(19) United States
(12) Patent Application Publication
(10) Pub. No.: US 2026/0365446 A1
(43) Pub. Date: Nov. 19, 2026

(54) CONVEYOR ASSEMBLY INCLUDING DAMPER ASSEMBLIES FOR POSITIONING A BLADE

(71) Applicant: RICHWOOD INDUSTRIES, INC., Huntington, WV (US)

(72) Inventors: Christopher Scott Smith, Huntington, WV (US); Eric L. Addison, Salt Rock, WV (US); Glenn E. Farrow, Grayson, KY (US); Joshua M. Smith, Willow Wood, OH (US)

(21) Appl. No.: 19/210,562

(22) Filed: May 16, 2025

(51) Int. Cl. B65G 45/16; F16F 15/04; F16H 37/12; H02K 7/06

(52) U.S. Cl. CPC B65G 45/16; F16F 15/04; F16H 37/122; H02K 7/06; F16F 2230/28

(57) ABSTRACT

A conveyor assembly including a belt cleaner tension system for positioning a blade relative to a surface of a conveyor belt is disclosed. The belt cleaner tension system includes a blade and a damper assembly. The damper assembly includes a damper, a motor operable to position the damper between a retracted position and an extended position, a current sensor for measuring a current of the motor, a damper linkage rotatably coupled to the damper, and a blade linkage pivotally coupled to the damper linkage and a first end of the blade. When the current sensor detects a current of the motor being less than a predetermined current threshold, the motor is operated in a first mode such that the damper is moved toward the extended position and the blade is moved toward a contact position.

### TECHNICAL FIELD

The present specification generally relates to systems and methods for removing debris from a conveyor belt and, more specifically, conveyor assemblies and methods for positioning a blade relative to a surface of a conveyor belt.

### BACKGROUND

Conveyor assemblies are widely used in various industries for the efficient transportation of materials. These systems typically consist of a continuous belt that moves over rollers, carrying materials from one point to another. Over time, debris and residue can accumulate on the surface of the conveyor belt, which can lead to operational inefficiencies, increased wear and tear, and potential damage to the belt and other components. To address this issue, cleaning blades are employed to remove debris from the surface of the conveyor belt. These blades are designed to scrape off unwanted materials, ensuring the belt remains clean and functional, thereby extending the lifespan of the conveyor assembly and maintaining optimal performance.

The effectiveness of these cleaning blades largely depends on their precise positioning relative to the conveyor belt. If the blade is not correctly aligned, the blade may fail to remove debris effectively, or the blade could cause excessive wear on the belt. Therefore, there is a critical need for mechanisms that allow for the specific positioning and adjustment of the cleaning blade. Such mechanisms ensure that the blade maintains consistent contact with the belt surface, adapting to any changes in belt tension or alignment.

### SUMMARY

In one embodiment, a belt cleaner tension system includes: a blade; and a damper assembly including: a damper; a motor operable to position the damper between a retracted position and an extended position; a current sensor for measuring a current of the motor; a damper linkage rotatably coupled to the damper; and a blade linkage pivotally coupled to the damper linkage and a first end of the blade, wherein, when the current sensor detects a current of the motor being less than a predetermined current threshold, the motor is operated in a first mode such that the damper is moved toward the extended position and the blade is moved toward a contact position.

In another embodiment, a conveyor assembly includes: a frame; a conveyor belt extending through an open interior of the frame; a blade positioned within the open interior of the frame; and a first damper assembly coupled to the frame, the first damper assembly including: a damper; a motor operable to position the damper between a retracted position and an extended position; a current sensor for measuring a current of the motor; a damper linkage rotatably coupled to the damper; and a blade linkage fixed to the damper linkage and a first end of the blade, wherein, when the current sensor detects a current of the motor being less than a predetermined current threshold, the motor is operated in a first mode such that the damper is moved toward the extended position and the blade is moved toward a contact position to contact an outer surface of the conveyor belt.

In yet another embodiment, a method includes: detecting a current of a motor; operating the motor in a first mode to position a damper of a damper assembly toward an extended position in response to determining that the current of the motor is below a predetermined current threshold; and operating the motor in a second mode to position a damper toward a retracted position in response to determining that the current of the motor is above the predetermined current threshold.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a top view of a conveyor assembly, according to one or more embodiments shown and described herein;

FIG. 2 schematically depicts a partial side view of the conveyor assembly including a first damper assembly in a nonactuated state, according to one or more embodiments shown and described herein;

FIG. 3 schematically depicts a partial side view of the conveyor assembly including the first damper assembly in an actuated state, according to one or more embodiments shown and described herein;

FIG. 4 schematically depicts a front view of a first damper and a first motor assembly of the first damper assembly, according to one or more embodiments shown and described herein;

FIG. 5 schematically depicts a side view of the first damper, according to one or more embodiments shown and described herein;

FIG. 6 schematically depicts an exploded view of the first damper and the first motor assembly, according to one or more embodiments shown and described herein;

FIG. 7 schematically depicts a cross-sectional front view of the first damper in a retracted position and the first motor assembly, according to one or more embodiments shown and described herein;

FIG. 8 schematically depicts a cross-sectional front view of the first damper in an extended position and the first motor assembly, according to one or more embodiments shown and described herein;

FIG. 9 schematically depicts a cross-sectional front view of the first damper in a compressed position and the first motor assembly, according to one or more embodiments shown and described herein;

FIG. 10 schematically depicts individual electronic components of the conveyor assembly, according to one or more embodiments shown and described herein;

FIG. 11 depicts a flowchart of a method for operating the conveyor assembly, according to one or more embodiments shown and described herein; and

FIG. 12 depicts a flowchart of the method for operating the conveyor assembly, according to one or more embodiments shown and described herein.

### DETAILED DESCRIPTION

Embodiments described herein are directed to a conveyor assembly that includes a belt cleaner tension system for positioning a blade relative to a surface of a conveyor belt. The belt cleaner tension system includes a blade and a damper assembly. The damper assembly includes a damper, a motor operable to position the damper between a retracted position and an extended position, a current sensor for measuring a current of the motor, a damper linkage rotatably coupled to the damper, and a blade linkage pivotally coupled to the damper linkage and a first end of the blade. When the current sensor detects a current of the motor being less than a predetermined current threshold, the motor is operated in a first mode such that the damper is moved toward the extended position and the blade is moved toward a contact position. Various embodiments of the conveyor apparatus and the operation of the conveyor apparatus are described in more detail herein. Whenever possible, the same reference numerals will be used throughout the drawings to refer to the same or like parts.

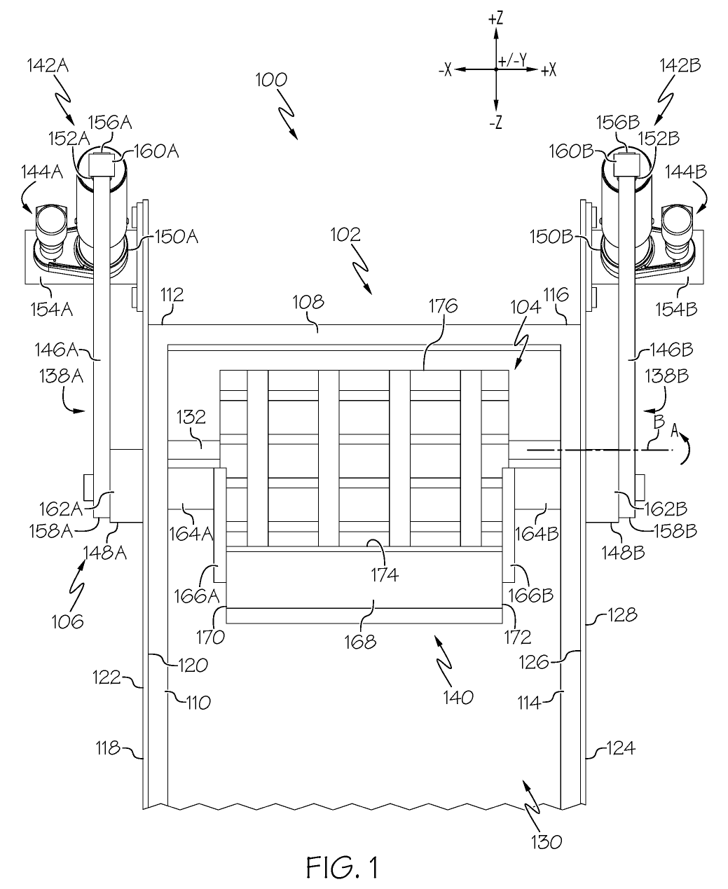

As used herein, the term “longitudinal direction” refers to the forward-rearward direction of the conveyor assembly (i.e., in the +/- Y direction of the coordinate axes depicted in FIG. 1A). The term “lateral direction” refers to the cross direction (i.e., in the +/- X direction of the coordinate axes depicted in FIG. 1A), and is transverse to the longitudinal direction. The term “vertical direction” refers to the upward-downward direction of the conveyor assembly (i.e., in the +/- Z direction of the coordinate axes depicted in FIG. 1A). As used herein, “upper” and “above” are defined as the positive Z direction of the coordinate axes shown in the drawings. “Lower” and “below” are defined as the negative Z direction of the coordinate axes shown in the drawings.

Directional terms as used herein - for example up, down, right, left, front, back, top, bottom - are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Referring now to FIG. 1, a conveyor assembly 100 is illustrated according to one or more embodiments described herein. The conveyor assembly 100 generally includes a frame 102, a conveyor belt 104 rotatably coupled to the frame 102, and a belt cleaner tension system 106. As shown in FIG. 1, the frame 102 includes an upper pillar 108, a first side pillar 110 extending from a first end 112 of the upper pillar 108, and a second side pillar 114 opposite the first side pillar 110 and extending from an opposite second end 116 of the upper pillar 108. The first side pillar 110 and the second side pillar 114 function as legs or supports for the frame 102 of the conveyor assembly 100 on a ground surface. Although not shown, it should be appreciated that the frame 102 may include a plurality of first side pillars 110 and a plurality of second side pillars 114 extending from one or more upper pillars 108 to further support the frame 102 on the ground surface.

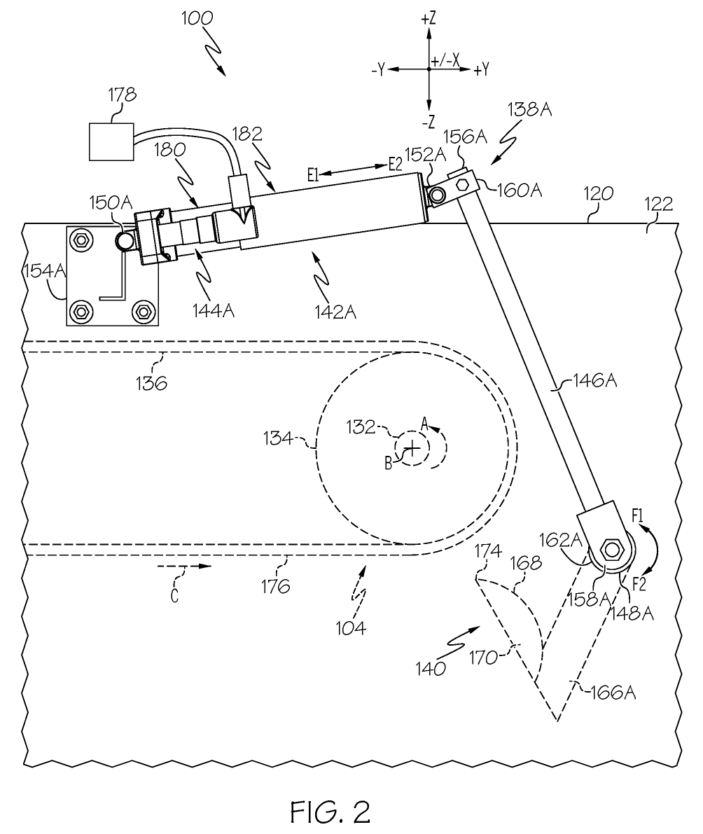

In embodiments, a first side plate 118 is mounted at the first end 112 of the upper pillar 108 across the one or more first side pillars 110. The first side plate 118 includes an inner surface 120 facing the first side pillar 110 and an outer surface 122 opposite the inner surface 120. Similarly, a second side plate 124 is mounted at the second end 116 of the upper pillar 108 across the one or more second side pillars 114. The second side plate 124 includes an inner surface 126 facing the second side pillar 114 and an outer surface 128 opposite the inner surface 126. The first side plate 118 and the second side plate 124 at least partially enclose an open interior 130 of the frame 102 in which a portion of the conveyor belt 104 is positioned. A shaft 132 extends between the first side plate 118 and a second side plate 124, and the conveyor belt 104 extends around the shaft 132. As shown in FIG. 2, a driver roller 134 is provided on the shaft 132 and engages an inner surface 136 of the conveyor belt 104. The driver roller 134 is configured to rotate in a rotation direction as indicated by arrow A about a shaft axis B defined by the shaft 132 via any suitable arrangement, such as a belt, chain, pulley or the like. Thus, rotation of the driver roller 134 translates the conveyor belt 104 in a conveying direction as indicated by arrow C.

Referring again to FIG. 1, the belt cleaner tension system 106 includes a pair of damper assemblies 138A, 138B provided on opposite sides of the frame 102 and a blade 140 extending between each of the damper assemblies 138A, 138B. As shown, a first damper assembly 138A is provided at the outer surface 122 of the first side plate 118, and a second damper assembly 138B is provided at the outer surface 128 of the second side plate 124.

The first damper assembly 138A includes a first damper 142A, a first motor assembly 144A, a first damper linkage 146A extending from the first damper 142A, and a first pivot 148A. As shown in FIG. 2, the first damper 142A includes a fixed end 150A and a free end 152A opposite the fixed end 150A. The first damper assembly 138A includes a first bracket 154A mounted to the outer surface 122 of the first side plate 118. The fixed end 150A of the first damper 142A and the first motor assembly 144A are mounted to the first bracket 154A. The first damper linkage 146A includes a first end 156A and a second end 158A opposite the first end 156A. The first end 156A of the first damper linkage 146A is pivotally coupled to the free end 152A of the first damper 142A via a first connector 160A. The second end 158A of the first damper linkage 146A is fixed to the first pivot 148A. Referring again to FIG. 1, the first pivot 148A includes an outer pivot portion 162A provided at the outer surface 122 of the first side plate 118 and an inner pivot portion 164A provided at the inner surface 120 of the first side plate 118. A first blade linkage 166A extends between the inner pivot portion 164A of the first pivot 148A and the blade 140.

The second damper assembly 138B includes a second damper 142B, a second motor assembly 144B, a second damper linkage 146B extending from the second damper 142B, and a second pivot 148B. Similar to the first damper assembly 138A, the second damper 142B includes a fixed end 150B and a free end 152B opposite the fixed end 150B. The second damper assembly 138B includes a second bracket 154B mounted to the outer surface 128 of the second side plate 124. The fixed end 150B of the second damper 142B and the second motor assembly 144B are mounted to the second bracket 154B. The second damper linkage 146B includes a first end 156B and a second end 158B opposite the first end 156B. The first end 156B of the second damper linkage 146B is pivotally coupled to the free end 152B of the second damper 142B via a second connector 160B. The second end 158B of the second damper linkage 146B is fixed to the second pivot 148B. The second pivot 148B includes an outer pivot portion 162B provided at the outer surface 128 of the second side plate 124 and an inner pivot portion 164B provided at the inner surface 126 of the second side plate 124. A second blade linkage 166B extends between the inner pivot portion 164B of the second pivot 148B and the blade 140.

Referring still to FIG. 1, the blade 140 is shown positioned below the conveyor belt 104 in the vertical direction (-Z direction). The blade 140 includes a blade body 168 having a first end 170 facing the first side plate 118 and a second end 172 opposite the first end 170 facing the second side plate 124. The first blade linkage 166A extends between the inner pivot portion 164A of the first pivot 148A and the first end 170 of the blade body 168. The second blade linkage 166B extends between the inner pivot portion 164B of the second pivot 148B and the second end 172 of the blade body 168. The blade body 168 includes a tip 174 configured to contact an outer surface 176 of the conveyor belt 104. Accordingly, with the tip 174 of the blade body 168 contacting the outer surface 176 of the conveyor belt 104 and the conveyor belt 104 moving in the conveying direction C, debris accumulating on the outer surface 176 of the conveyor belt 104 may be removed by the blade 140.

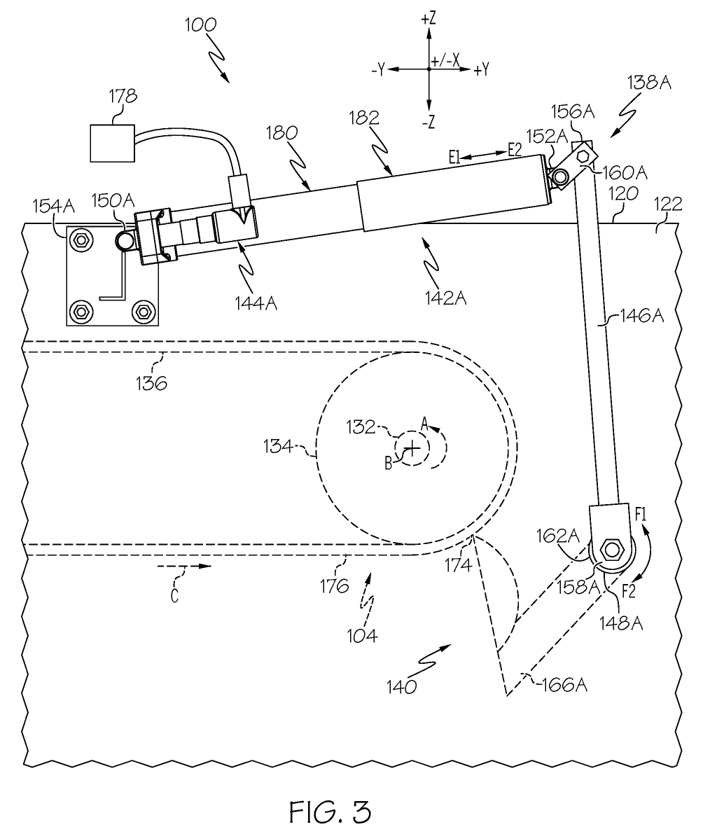

Referring again to FIGS. 2 and 3, various positions of the first damper 142A of the first damper assembly 138A and the blade 140 are depicted. However, it should be appreciated that the second damper assembly 138B may be similarly operated. Specifically, the damper assemblies 138A, 138B are operable to position the first damper 142A and the second damper 142B between a retracted position (FIG. 2) and an extended position (FIG. 3). Additionally, the damper assemblies 138A, 138B are operable to position the blade 140 between a noncontact position (FIG. 2), in which the tip 174 of the blade 140 is spaced apart from the outer surface 176 of the conveyor belt 104, and a contact position (FIG. 3), in which the tip 174 of the blade 140 contacts the outer surface 176 of the conveyor belt 104.

As described in more detail herein, the belt cleaner tension system 106 includes an electronic control unit (ECU) 178 configured to independently operate each of the damper assemblies 138A, 138B to position respective ends 170, 172 of the blade body 168 relative to the conveyor belt 104. Accordingly, the damper assemblies 138A, 138B are each operable between a nonactuated state (FIG. 2) and an actuated state (FIG. 3). As described in more detail herein, when the damper assemblies 138A, 138B are in the nonactuated state, the first damper 142A and the second damper 142B are in the retracted position, and respective ends 170, 172 of the blade body 168 are in the noncontact position and spaced apart from the outer surface 176 of the conveyor belt 104. Alternatively, when the damper assemblies 138A, 138B are in the actuated state, the first damper 142A and the second damper 142B are in the extended position, and respective ends 170, 172 of the blade body 168 are in the contact position and contact the outer surface 176 of the conveyor belt 104. However, as described in more detail herein, while the damper assemblies 138A, 138B are in either the actuated state, the first damper 142A and the second damper 142B are permitted to be compressed from the extended position to the retracted position, and thus the blade 140 is positionable from the contact position to the noncontact position.

With respect to the first damper assembly 138A, and as described in more detail herein, the first damper 142A includes an inner housing 180 and an outer housing 182. When the first damper assembly 138A is positioned in the unactuated state, as shown in FIG. 2, the first damper 142A is in the retracted position such that the outer housing 182 is moved in a first linear direction as depicted by arrow E1 relative to the inner housing 180. In doing so, the outer housing 182 draws the first damper linkage 146A closer to the inner housing 180, thereby rotating the first pivot 148A in the direction of arrow F1. Rotation of the first pivot in the direction of arrow F1 similarly rotates the first blade linkage 166A and the first end 170 of the blade body 168 into the noncontact position away from the outer surface 176 of the conveyor belt 104.

Alternatively, when the first damper assembly 138A is positioned in the actuated state, as shown in FIG. 3, the first damper 142A is in the extended position such that the outer housing 182 is moved in a second linear direction as depicted by arrow E2 relative to the inner housing 180 opposite the first linear direction E1. In doing so, the outer housing 182 pushes the first damper linkage 146A further from the inner housing 180, thereby rotating the first pivot 148A in the direction of arrow F2 opposite the direction of arrow F1. Rotation of the first pivot 148A in the direction of arrow F2 similarly rotates the first blade linkage 166A and the first end 170 of the blade body 168 into the contact position against the outer surface 176 of the conveyor belt 104. Although not depicted herein, the second damper assembly 138B is similarly operable to position the second end 172 of the blade body 168 between the noncontact position and the contact position relative to the outer surface 176 of the conveyor belt 104.

It should be appreciated that the damper assemblies 138A, 138B are positionable between one or more intermediate states between the nonactuated state and the actuated state by positioning the first damper 142A and the second damper 142B, respectively, into an intermediate position between the retracted position and the extended position. Additionally, the first damper assembly 138A may be positioned in a different state than that of the second damper assembly 138B to appropriately position the first end 170 and the second end 172 of the blade body 168 relative to the conveyor belt 104 given an amount of debris accumulating on the outer surface 176 of the conveyor belt 104.

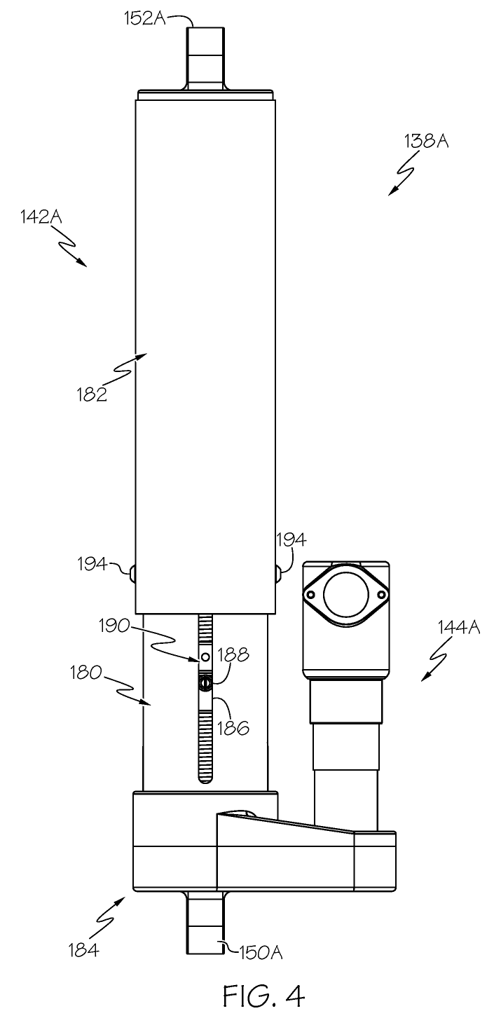

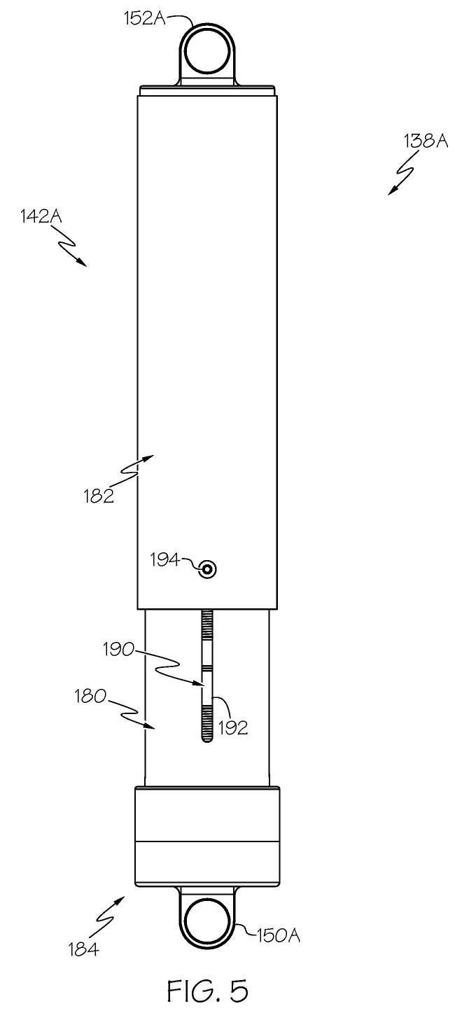

Referring now to FIGS. 4 and 5, a front view and a side view of the first damper assembly 138A are respectively depicted. As the first damper assembly 138A and the second damper assembly 138B are identical in structure, only the first damper assembly 138A is described in detail herein. However, it should be appreciated that the description of the first damper assembly 138A is equally applicable to the second damper assembly 138B.

As described herein, the first damper assembly 138A includes the first damper 142A and the first motor assembly 144A. The first damper 142A generally includes the inner housing 180 and the outer housing 182, which surrounds a portion of the inner housing 180 and is translatable relative to the inner housing 180. The first damper 142A further includes a mount 184 to which the inner housing 180 and the first motor assembly 144A are mounted.

The inner housing 180 includes a pair of first slots 186 formed therein, only one of which is shown in FIG. 4. As described in more detail herein, the first slots 186 receive respective inner pins 188 extending from opposite sides of a nut 190 to inhibit rotation of the nut 190 provided within the inner housing 180. Additionally, the inner housing 180 includes a pair of second slots 192 formed therein, only one of which is shown in FIG. 5. As described in more detail herein, the second slots 192 receive respective outer pins 194 extending from opposite sides of the outer housing 182 to inhibit rotation of the outer housing 182 during translation of the outer housing 182 relative to the inner housing 180.

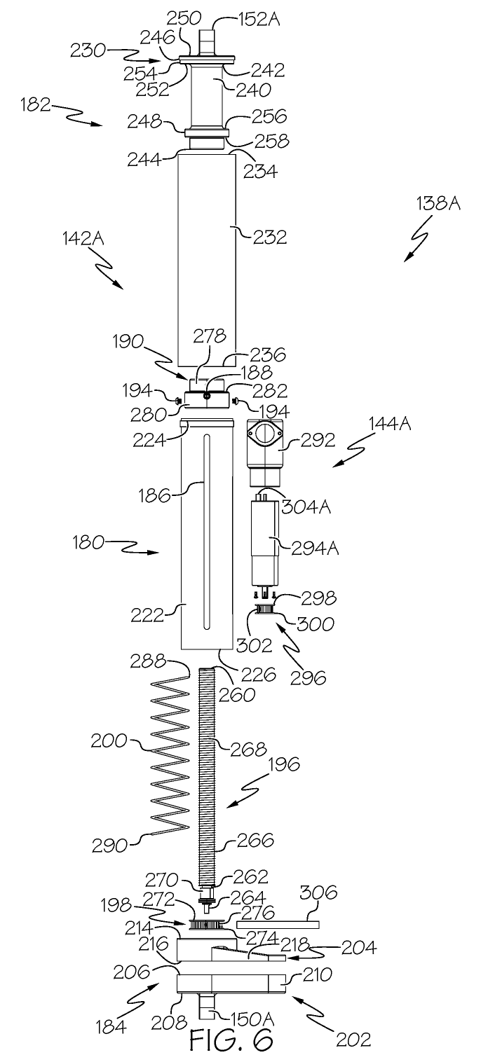

Referring now to FIG. 6, an exploded view of the first damper assembly 138A is depicted. The first damper assembly 138A includes the first damper 142A and the first motor assembly 144A. The first damper 142A generally includes the mount 184, the inner housing 180, the outer housing 182, a screw 196, a screw gear 198, the nut 190, and a biasing member 200.

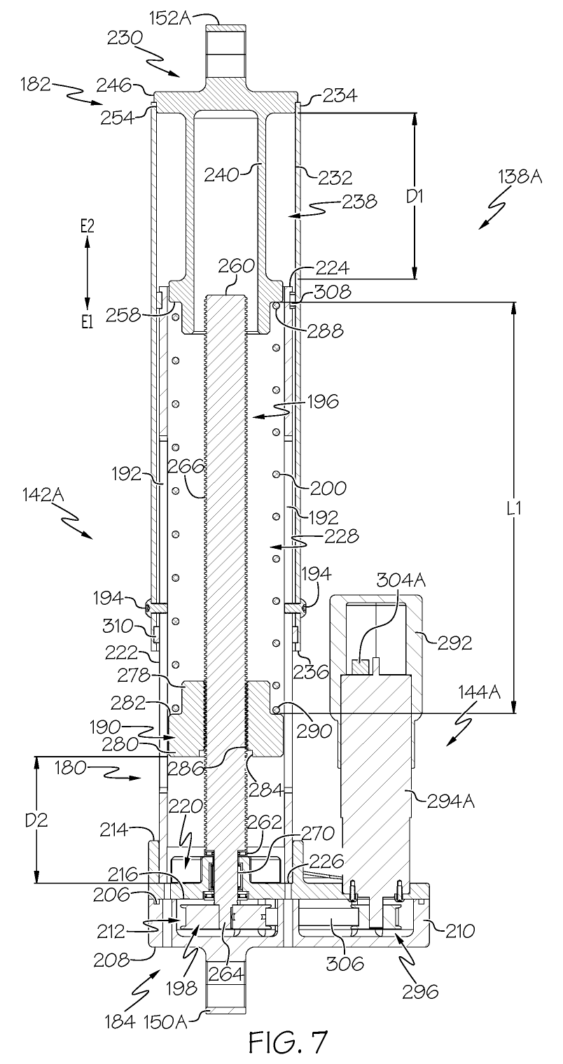

The mount 184 includes a lower mount portion 202 and an upper mount portion 204. The lower mount portion 202 includes an upper edge 206, a lower surface 208 opposite the upper edge 206, a flange 210 extending in an outward radial direction, and the fixed end 150A provided at the lower surface 208. The lower mount portion 202 defines an open interior 212 extending from the lower surface 208 to the upper edge 206. Additionally, the open interior 212 extends within the flange 210. The upper mount portion 204 includes an upper edge 214, a lower surface 216 opposite the upper edge 214, and a flange 218 extending in an outward radial direction. The upper mount portion 204 defines an open interior 220 (FIG. 7) extending from the lower surface 216 to the upper edge 214.

The inner housing 180 includes a body 222 having an upper end 224 and a lower end 226 opposite the upper end 224 and defining an open interior 228 formed therein. As described herein, the inner housing 180 includes the pair of first slots 186 formed therein and provided on opposite sides of the body 222 of the inner housing 180, only one of which is shown in FIG. 6. Additionally, the inner housing 180 includes the pair of second slots 192 formed therein, only one of which is shown in FIG. 5.

The outer housing 182 includes a spindle 230 and a body 232. The body 232 of the outer housing 182 has an upper end 234 and a lower end 236 opposite the upper end 234 and defines an open interior 238 formed therein. As described in more detail herein, the inner housing 180 is insertable into the open interior 238 of the body 232 of the outer housing 182 through the lower end 236 of the body 232. In embodiments, the outer housing 182 includes the pair of outer pins 194 that extend through the body 232 of the outer housing 182 and into the open interior 238 of the body 232. As described in more detail herein, the outer pins 194 engage the second slots 192 formed in the inner housing 180 to inhibit rotation of the outer housing 182 relative to the inner housing 180.

The spindle 230 includes a shaft 240 having an upper end 242 and a lower end 244 opposite the upper end 242, an upper flange 246 formed at the upper end 242 of the shaft 240, the free end 152A provided at the upper flange 246 opposite the shaft 240, and a lower flange 248 formed proximate the lower end 244 of the shaft 240. The upper flange 246 and the lower flange 248 extend in outer radial directions from the shaft 240. The upper flange 246 includes an upper surface 250 facing the free end 152A, and a lower surface 252 opposite the upper surface 250 facing the shaft 240. The lower surface 252 of the upper flange 246 defines a shoulder 254. The lower flange 248 includes an upper surface 256 facing the free end 152A, and an upper spring seat 258 opposite the upper surface 256. The spindle 230 is insertable into the open interior 238 of the body 232 of the outer housing 182 through the upper end 234. With the spindle 230 inserted into the body 232 of the outer housing 182, the upper end 234 of the body 232 engages the shoulder 254 of the upper flange 246 of the spindle 230 to support the spindle 230.

Referring still to FIG. 6, the screw 196 includes an upper end 260, a lower end 262 opposite the upper end 260, and a fastener 264 extending from the lower end 262 in a direction opposite the upper end 260. The screw 196 includes external threads 266 formed on an outer surface 268 of the screw 196 extending between the upper end 260 and the lower end 262. In embodiments, a roller bearing 270 is provided at the lower end 262 of the screw 196 and circumscribes the fastener 264. The roller bearing 270 is received within the upper mount portion 204 of the mount 184 and the fastener 264 extends through the upper mount portion 204 and into the open interior 212 of the lower mount portion 202. With the screw 196 extending from mount 184, the screw 196 extends within the open interior 228 of the inner housing 180.

The screw gear 198 includes an upper rim 272, a lower rim 274 opposite the upper rim 272, and a plurality of ribs 276 extending between the upper rim 272 and the lower rim 274. The upper rim 272 and the lower rim 274 extend in a radial direction further than the ribs 276. As described in more detail herein, the screw gear 198 is positionable within the open interior 212 of the lower mount portion 202 of the mount 184 and engages the fastener 264 of the screw 196 such that rotation of the screw gear 198 results in corresponding rotation of the screw 196.

The nut 190 includes an upper nut portion 278 and a lower nut portion 280 extending from the upper nut portion 278. A diameter of the upper nut portion 278 is less than a diameter of the lower nut portion 280. Thus, the lower nut portion 280 defines a lower spring seat 282 facing the upper nut portion 278. As described herein, the nut 190 includes the pair of inner pins 188, only one of which is shown, extending in an outer radial direction from the lower nut portion 280. The nut 190 defines a channel 284 (FIG. 7) extending through the upper nut portion 278 and the lower nut portion 280 and defines internal threads 286 (FIG. 7). As described in more detail herein, the internal threads 286 of the nut 190 are configured to engage the external threads 266 of the screw 196. With the nut 190 positioned within the open interior 228 of the inner housing 180, the inner pins 188 are configured to extend through a respective first slot 186 to inhibit rotation of the nut 190 relative to the inner housing 180 and restrict the nut 190 to linear movement within the inner housing 180 along the screw 196.

The biasing member 200 has an upper end 288 and a lower end 290 opposite the upper end 288. As depicted herein, the biasing member 200 is a spring. However, the biasing member 200 may be any suitable resilient member, such as a compressible foam, rubber, or the like. The biasing member 200 is positionable within the open interior 228 of the inner housing 180. Specifically, the upper end 288 of the biasing member 200 is positioned against the upper spring seat 258 of the spindle 230, and the lower end 290 of the biasing member 200 is positioned against the lower spring seat 282 of the nut 190. In embodiments, the upper end 288 of the biasing member 200 is fixed to the upper spring seat 258 of the spindle 230. Additionally, in embodiments, the lower end 290 of the biasing member 200 is fixed to the lower spring seat 282 of the nut 190.

Referring still to FIG. 6, the first motor assembly 144A includes a motor cap 292, a first motor 294A partially housed within the motor cap 292, and a motor gear 296 provided at an end of the first motor 294A opposite the motor cap 292. In embodiments, the motor 294A is an electric motor. The motor gear 296 includes an upper rim 298, a lower rim 300 opposite the upper rim 298, and a plurality of ribs 302 extending between the upper rim 298 and the lower rim 300. The upper rim 298 and the lower rim 300 extend in a radial direction past the ribs 302. As described in more detail herein, the motor gear 296 is positionable within the open interior 212 of the lower mount portion 202 of the mount 184 and engages the first motor 294A. Accordingly, operation of the first motor 294A in a first mode results in rotation of the motor gear 296 in a first direction, and operation of the first motor 294A in second mode results in rotation of the motor gear 296 in an opposite second direction.

In embodiments, the first motor assembly 144A includes a first current sensor 304A to detect a current being imparted on the first motor 294A. The first current sensor 304A may transmit the detected current data to the ECU 178 (FIG. 1) and the ECU 178 may process the current data received to determine whether the first motor 294A is being overworked or underworked.

A belt 306 extends between the screw gear 198 and the motor gear 296 to couple the screw gear 198 to the motor gear 296. The belt 306 is maintained on the screw gear 198 by the upper rim 272 and the lower rim 274 of the screw gear 198, and is maintained on the motor gear 296 by the upper rim 298 and the lower rim 300 of the motor gear 296. Accordingly, as described in more detail herein, rotation of the motor gear 296 by operation of the first motor 294A results in rotation of the belt 306 around the motor gear 296 and a corresponding rotation of the screw gear 198 by the rotation of the belt 306 around the screw gear 198. The first motor assembly 144A, the screw 196, the screw gear 198, the nut 190, and the belt 306 cooperate to form a linear displacement mechanism.

As described herein, the damper assemblies 138A, 138B are positionable between the nonactuated state and the actuated state. Additionally, the damper assemblies 138A, 138B are positionable into one or more intermediate states between the nonactuated state and the actuated state. With respect to FIGS. 7-9, a partial view of the first damper assembly 138A is depicted in each of the nonactuated state and the actuated state. Specifically, FIGS. 7-9 depict the first damper 142A in the retracted position, the extended position, and a compressed position, respectively. It should be appreciated that the second damper assembly 138B operates in the same manner as the first damper assembly 138A described herein.

Referring now to FIG. 7, a partial cross-sectional view of the first damper assembly 138A is depicted in the nonactuated state with the first damper 142A depicted in the retracted position. As shown, the first motor assembly 144A is mounted to the mount 184 with the motor gear 296 positioned within the open interior 212 of the lower mount portion 202. Additionally, the screw 196 extends from the mount 184 with the screw gear 198 positioned within the open interior 212 of the lower mount portion 202. As described herein, the belt 306 is positioned within the open interior 212 of the lower mount portion 202 and extends around the motor gear 296 and the screw gear 198 such that rotation of the motor gear 296 results in a corresponding rotation of the screw gear 198.

The screw 196 is depicted extending through the open interior 228 of the inner housing 180, and the nut 190 positioned on the screw 196 with the internal threads 286 of the nut 190 engaging the external threads 266 of the screw 196. As described herein and depicted in FIG. 4, the inner pins 188 extending from the nut 190 are received in the first slots 186 to inhibit rotation of the nut 190 as the screw 196 rotates and the nut 190 traverses along the screw 196. Referring again to FIG. 7, the spindle 230 is received within the open interior 238 of the body 232 of the outer housing 182. Specifically, the upper end 234 of the body 232 of the outer housing 182 engages the shoulder 254 formed in the upper flange 246 of the spindle 230. As described herein, the outer pins 194 of the outer housing 182 extend through the body 232 of the outer housing 182 and into respective second slots 192 formed in the inner housing 180 to inhibit rotation of the outer housing 182 relative to the inner housing 180.

The biasing member 200 is positioned within the open interior 228 of the inner housing 180 between the upper spring seat 258 of the spindle 230 and the lower spring seat 282 of the nut 190. As described herein, in embodiments, the upper end 288 of the biasing member 200 is fixed to the upper spring seat 258 of the spindle 230. Additionally, in embodiments, the lower end 290 of the biasing member 200 is fixed to the lower spring seat 282 of the nut 190.

In embodiments, an upper seal 308 is provided at the upper end 224 of the body 222 of the inner housing 180 and is retained within the inner housing 180. The upper seal 308 is provided between the inner housing 180 and the outer housing 182 to prevent wear on the outer housing 182 during operation. Additionally, in embodiments, a lower seal 310 is provided at the lower end 236 of the body 232 of the outer housing 182 and is retained within the outer housing 182. The lower seal 310 is provided between the inner housing 180 and the outer housing 182 to prevent wear on the inner housing 180 during operation.

In the nonactuated state, the upper flange 246 is spaced apart from the upper end 224 of the body 222 of the inner housing 180 by a first distance D1. The nut 190 is shown in a lowered position relative to the screw 196 such that the nut 190 is spaced apart from the lower end 226 of the body 222 of the inner housing 180 by a second distance D2. Additionally, the biasing member 200 is shown in an uncompressed position having a first length L1.

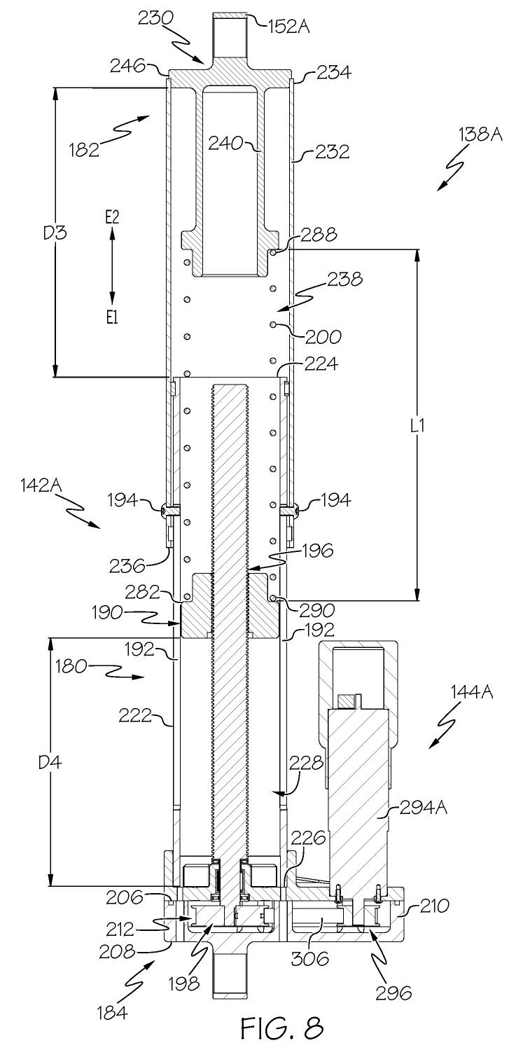

Referring now to FIG. 8, a partial cross-sectional view of the first damper assembly 138A is depicted in the actuated state and the first damper 142A is depicted in the extended position. To position the first damper assembly 138A into the actuated state from the nonactuated state, the first motor 294A is operated in a first mode to rotate the motor gear 296 in a first direction, which results in the screw gear 198 rotating in the first direction due to the screw gear 198 being coupled to the motor gear 296 by the belt 306. The screw gear 198 rotating in the first direction results in the screw 196 also rotating in the first direction.

As the nut 190 is inhibited from rotating relative to the screw 196, rotation of the screw 196 in the first direction results in the nut 190 traversing the screw 196 in the second linear direction E2 toward the spindle 230. This results in the nut 190 pushing the biasing member 200, which pushes the outer housing 182 in the second linear direction E2 opposite the mount 184. As described herein, the outer housing 182 is inhibited from rotating relative to the inner housing 180 during movement of the outer housing 182 due to the outer pins 194 extending through the second slots 192 formed in the inner housing 180.

Accordingly, in the actuated state, the upper flange 246 is spaced apart from the upper end 224 of the body 222 of the inner housing 180 by a third distance D3 greater than the first distance D1 when the first damper assembly 138A is in the nonactuated state. Accordingly, a length of the first damper 142A between the fixed end 150A and the free end 152A when the first damper assembly 138A is in the actuated state is greater than a length of the first damper 142A when the first damper assembly 138A is in the nonactuated state. The nut 190 is shown in a raised position relative to the screw 196 such that the nut 190 is spaced apart from the lower end 226 of the body 222 of the inner housing 180 by a fourth distance D4 greater than the third distance D3 when the first damper assembly 138A is in the nonactuated state. Additionally, the biasing member 200 is shown in the uncompressed position having the first length L1.

It should be appreciated that the first damper assembly 138A is positioned back into the nonactuated state, as shown in FIG. 7, by operating the first motor 294A in a second mode. Specifically, the first motor 294A is operated in the second mode to rotate the motor gear 296 in an opposite second direction, which results in the screw gear 198 rotating in the second direction due to the screw gear 198 being coupled to the motor gear 296 by the belt 306. The screw gear 198 rotating in the second direction results in the screw 196 also rotating in the second direction.

As the nut 190 is inhibited from rotating relative to the screw 196, rotation of the screw 196 in the second direction results in the nut 190 traversing the screw 196 in the opposite first linear direction E1 toward the mount 184. In embodiments in which the lower end 290 of the biasing member 200 is fixed to the lower spring seat 282 of the nut 190, the nut 190 moving in the first linear direction E1 pulls the biasing member in the first linear direction E1 toward the mount 184. Similarly, in embodiments in which the upper end 288 of the biasing member 200 is fixed to the upper spring seat 258 of the spindle 230, the biasing member 200 moving in the first linear direction E1 pulls the spindle 230 in the first linear direction E1 toward the inner housing 180. As described herein, the outer housing 182 in inhibited from rotating relative to the inner housing 180 during movement of the outer housing 182 due to the outer pins 194 extending through the second slots 192 formed in the inner housing 180.

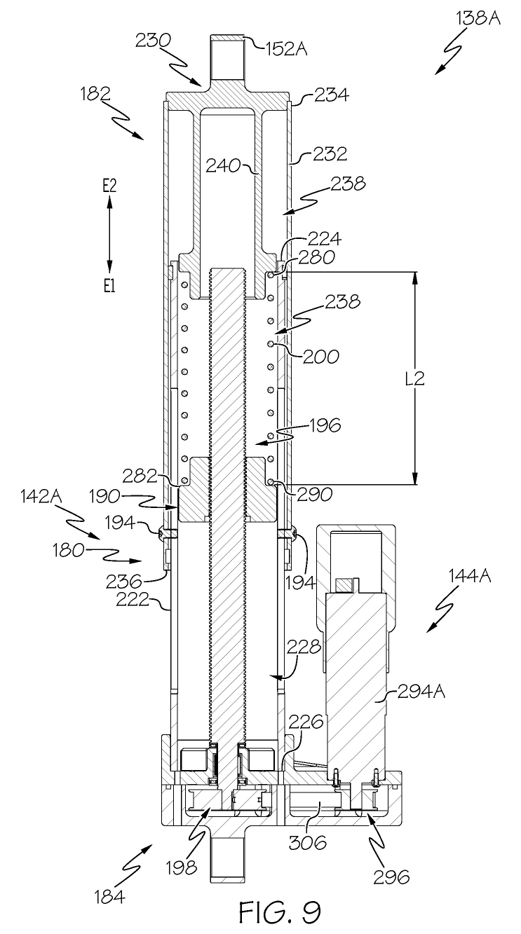

Referring now to FIG. 9, a partial cross-sectional view of the first damper assembly 138A is depicted in the actuated state with the first damper 142A in the compressed position, which occurs when a force is applied against the free end 152A of the first damper 142A, such as by the blade 140 (FIG. 1) contacting excess debris formed on the conveyor belt 104 (FIG. 1). In the compressed position, a force applied against the free end 152A results in the outer housing 182 moving in the first linear direction E1 toward the mount 184 while the nut 190 remains fixed in position on the screw 196. Accordingly, the biasing member 200 compresses into a compressed position to have a second length L2 less than the first length L1 of the biasing member 200 when in the uncompressed position, as shown in FIGS. 7 and 8. When the force applied against the free end 152A of the first damper 142A decreases, the biasing member 200 is urged back into the uncompressed position, thereby pushing the outer housing 182 in the second linear direction E2 opposite the mount 184 to position the first damper 142A back into the extended position, as shown in FIG. 8.

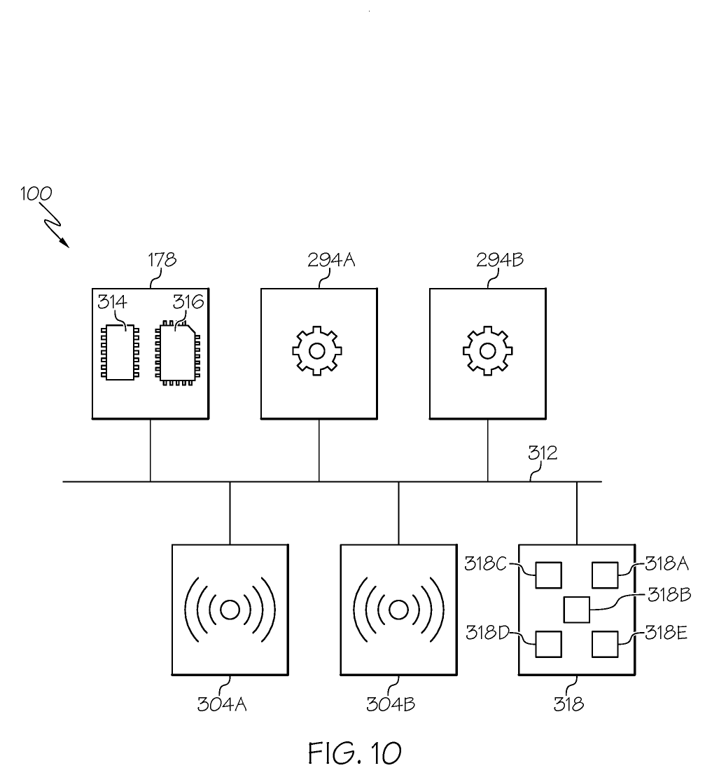

Referring now to FIG. 10, individual components of the conveyor assembly 100 are schematically depicted. In embodiments, the conveyor assembly 100 includes the ECU 178, the first motor 294A of the first damper assembly 138A (FIG. 1), the first current sensor 304A of the first damper assembly 138A, a second motor 294B of the second damper assembly 138B (FIG. 1), a second current sensor 304B of the second damper assembly 138B, and a user interface 318. The conveyor assembly 100 further includes a communication path 312 communicatively coupling the ECU 178, the first motor 294A, the first current sensor 304A, the second motor 294B, the second current sensor 304B, and the user interface 318. In embodiments, the second motor 294B is an electric motor. The various components of the conveyor assembly 100 and the interaction thereof will be described in more detail herein.

Still referring to FIG. 10, the communication path 312 may be formed from any medium that may be capable of transmitting a signal such as, for example, conductive wires, conductive traces, optical waveguides, or the like. Moreover, the communication path 312 may be formed from a combination of mediums capable of transmitting signals. In one embodiment, the communication path 312 comprises a combination of conductive traces, conductive wires, connectors, and buses that cooperate to permit the transmission of electrical data signals to components such as processors, memories, sensors, input devices, output devices, and communication devices. Accordingly, the communication path 312 may comprise a bus. Additionally, it is noted that the term “signal” may mean a waveform (e.g., electrical, optical, magnetic, mechanical or electromagnetic), such as DC, AC, sinusoidal-wave, triangular-wave, square-wave, vibration, and the like, capable of traveling through a medium. The communication path 312 communicatively couples the various components of the conveyor assembly. As used herein, the term “communicatively coupled” means that coupled components are capable of exchanging data signals with one another such as, for example, electrical signals via conductive medium, electromagnetic signals via air, optical signals via optical waveguides, and the like.

The ECU 178 includes a processor 314 and a memory module 316. The processor 314 may be any device capable of executing machine-readable instructions. Accordingly, the processor 314 may be a controller, an integrated circuit, a microchip, a computer, or any other computing device. The processor 314 may be communicatively coupled to the other components of the conveyor assembly 100 by the communication path 312. Accordingly, the communication path 312 may communicatively couple any number of processors 314 with one another, and allow the components coupled to the communication path 312 to operate in a distributed computing environment. Specifically, some or all of the components may operate as a node that may send and/or receive data. While FIG. 10 depicts a single processor 314, other embodiments may include more than one processor 314.

Still referring to FIG. 10, the memory module 316 of the conveyor assembly 100 may be coupled to the communication path 312 and communicatively coupled to the processor 314. The memory module 316 may comprise RAM, ROM, flash memories, hard drives, or any non-transitory memory device capable of storing machine-readable instructions such that the machine-readable instructions can be accessed and executed by the processor 314. The machine-readable instructions may comprise logic or algorithm(s) written in any programming language of any generation (e.g., 1GL, 2GL, 3GL, 4GL, or 5GL) such as, for example, machine language that may be directly executed by the processor 314, or assembly language, object-oriented programming (OOP), scripting languages, microcode, etc., that may be compiled or assembled into machine-readable instructions and stored in the memory module 316. Alternatively, the machine-readable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in computer programming language, as pre-programmed hardware elements, or as a combination of hardware and software components. While FIG. 10 depicts a single memory module 316, other embodiments may include more than one memory module 316.

During initial setup of the conveyor assembly 100, and particularly the first damper assembly 138A and the second damper assembly 138B, the first current sensor 304A and the second current sensor 304B measure the flow of electrical current through the first motor 294A and the second motor 294B, respectively, to monitor and control performance of the first motor 294A and the second motor 294B. The first current sensor 304A and the second current sensor 304B may include shunt resistors, Hall effect sensors, current transformers, magnetic field sensors, and the like. In response to the first current sensor 304A detecting a current of the first motor 294A while operating in the first mode, the first current sensor 304A transmits the data to the ECU 178, which then determines whether the current of the first motor 294A is at or exceeds a predetermined current threshold. If so, operation of the first motor 294A in the first mode is ceased. Similarly, in response to the second current sensor 304B detecting a current of the second motor 294B while operating in the first mode, the second current sensor 304B transmits the data to the ECU 178, which then determines whether the current of the second motor 294B is at or exceeds the predetermined current threshold. If so, operation of the second motor 294B in the first mode is ceased.

The user interface 318 is coupled to the communication path 312 such that the communication path 312 communicatively couples the user interface 318 to other components of the conveyor assembly 100. The user interface 318 may be any device capable of transforming mechanical, optical, or electrical signals into a data signal capable of being transmitted with the communication path 312. Specifically, the user interface 318 may include any number of movable objects that each transform physical motion into a data signal that may be transmitted to over the communication path 312 such as, for example, a button, a switch, a knob, or the like. In embodiments, the user interface 318 includes a current selection button 318A for selecting a predetermined current threshold. The current selection button 318A may include one or more buttons or knobs for increasing and/or decreasing the predetermined current threshold. In embodiments, the user interface 318 includes a display device 318B for displaying the predetermined current threshold as selected by the current selection button 318A. In embodiments, the user interface 318 includes one or more damper buttons for controlling a position of the first damper 142A and the second damper 142B. For example, the user interface 318 may include an UP damper button 318C for operating the first motor 249A and the second motor 249B in the first mode and positioning the first damper 142A and the second damper 142B toward the extended position. Additionally, the user interface 318 may include a DOWN damper button 318D for operating the first motor 249A and the second motor 249B in the second mode and positioning the first damper 142A and the second damper 142B toward the retracted position. In embodiments, the user interface 318 also includes an AUTO damper button 318E for automatically positioning the first damper 142A and the second damper 142B in accordance with the method described herein. Although referred to herein as buttons, it should be appreciated that any controlling device such as switches, knobs, and the like may be suitable.

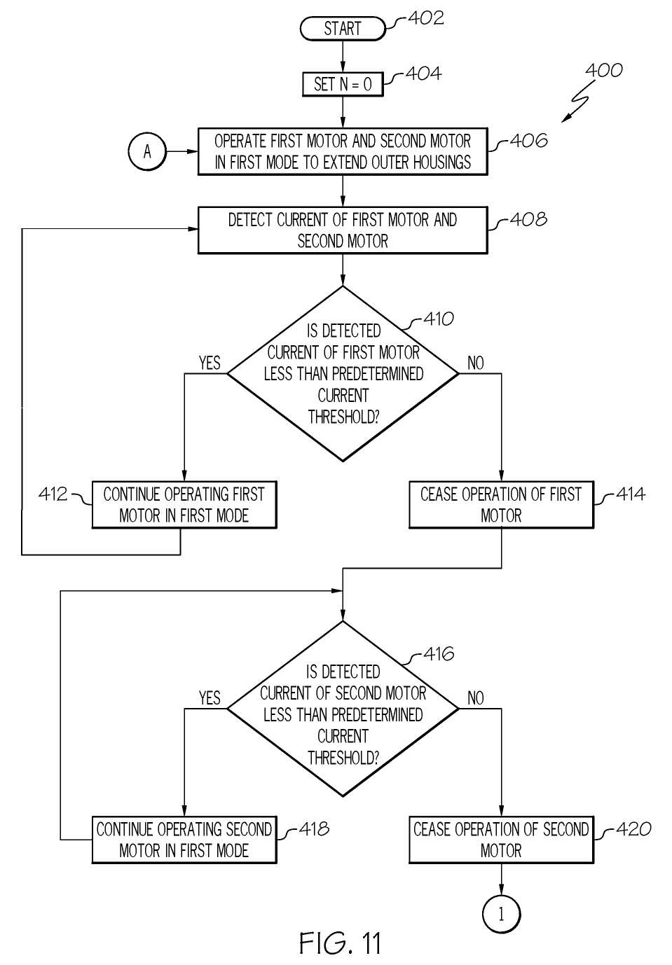

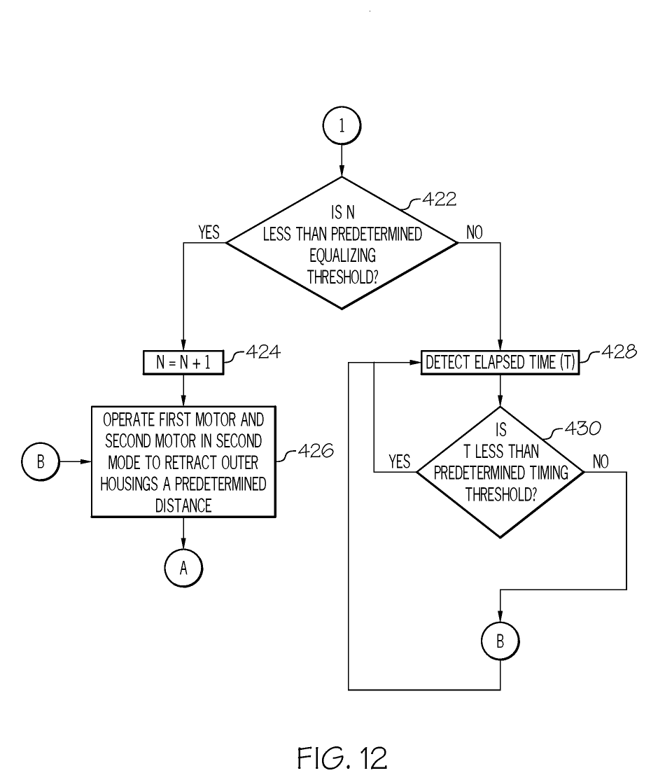

Referring now to FIGS. 11 and 12, flowcharts depicting a method 400 are illustrated. The method 400 is described herein with reference to the conveyor assembly 100 and individual components thereof illustrated in FIGS. 1-10 and described herein. Referring to FIG. 11, the method 400 starts at step 402. At step 404, the processor 314 sets a count N to 0. At step 406, the first motor 294A is operated in the first mode to move the first damper 142A toward the extended position. This positions the first end 170 of the blade body 168 closer to the outer surface 176 of the conveyor belt 104. Additionally, at step 406, the second motor 294B is operated in the first mode to move the second damper 142B toward the extended position. This positions the second end 172 of the blade body 168 closer to the outer surface 176 of the conveyor belt 104. Accordingly, the first motor 294A and the second motor 294B are simultaneously, yet independently operated.

At step 408, the first current sensor 304A of the first damper assembly 138A and the second current sensor 304B of the second damper assembly 138B detect a current of the first motor 294A and the second motor 294B, respectively. The data collected by the first current sensor 304A and the second current sensor 304B is transmitted to the ECU 178 for processing.

At step 410, the ECU 178 determines whether the current detected by the first current sensor 304A is less than a predetermined current threshold. The predetermined current threshold may be a particular current or, in some embodiments a current range. In embodiments, the predetermined current threshold is determined by averaging a number of readings by either one or both of the first current sensor 304A detected over a period of time. In embodiments, in which the predetermined current threshold includes a current range, the ECU 178 determines whether the current detected is less than the current range. Detecting a current of the first motor 294A being less than the predetermined current threshold is indicative of the first end 170 of the blade body 168 being not sufficiently contact with the outer surface 176 of the conveyor belt 104. Alternatively, detecting a current of the first motor 294A being above the predetermined current threshold is indicative of the blade 140 being in too much contact with the outer surface 176 of the conveyor belt 104.

If it determined at step 410 that the current detected by the first current sensor 304A is less than the predetermined current threshold, the method 400 proceeds to step 412 at which point the first motor 294A is operated in the first mode to move the first damper 142A toward the extended position. This positions the first end 170 of the blade body 168 closer to the outer surface 176 of the conveyor belt 104. Alternatively, if it determined at step 410 that the current detected by the first current sensor 304A is not less than, e.g., equal to or greater than, the predetermined current threshold, the method 400 proceeds to step 414 at which point operation of the first motor 294A is ceased.

The method 400 then proceeds to step 416 at which point the ECU 178 determines whether the current detected by the second current sensor 304B is less than the predetermined current threshold. If it determined at step 416 that the current detected by the second current sensor 304B is less than the predetermined current threshold, the method 400 proceeds to step 418 at which point the second motor 294B is operated in the first mode to move the second damper 142B toward the extended position. This positions the second end 172 of the blade body 168 closer to the outer surface 176 of the conveyor belt 104. Alternatively, if it determined at step 416 that the current detected by the second current sensor 304B is not less than, e.g., equal to or greater than, the predetermined current threshold, the method 400 proceeds to step 420 at which point operation of the second motor 294B is ceased. Thereafter, the method 400 proceeds to checkpoint 1. Accordingly, it should be appreciated that the first motor 294A and the second motor 294B are operated simultaneously, but independent of one another. Specifically, the first motor 294A and the second motor 294B are initially operated in the first mode at the same time. However, the first motor 294A and the second motor 294B may continue being operated in the first mode for different lengths of time.

Referring now to FIG. 12, following checkpoint 1, in embodiments, the method 400 proceeds to step 422 at which point the ECU 178 determines whether the count N is less than a predetermined equalizing threshold. If the ECU 178 determines at step 422 that the count N is less than the predetermined equalizing threshold, the method 400 proceeds to step 424 at which point the count N is set to N+1. Thereafter, at step 426, the first motor 294A and the second motor 294B are operated in the second mode to move the first damper 142A and the second damper 142B a predetermined distance toward the retracted position, or in some embodiments for a predetermined period of time. Thereafter, the method 400 proceeds to checkpoint A, which returns to step 406. Accordingly, the above steps 406-420 are performed to move the first damper 142A and the second damper 142B back toward the extended position.

Alternatively, if the ECU 178 determines at step 422 that the count N is not less than, e.g., equal to or greater than, the predetermined equalizing threshold, the method 400 proceeds to step 428 to detect an elapsed time T since the first damper 142A and the second damper 142B have been positioned. Over time, the tip 174 of the blade body 168 is worn such that the blade body 168 may not be in sufficient contact with the outer surface 176 of the conveyor belt 104. Accordingly, in embodiments, the conveyor assembly 100 will perform periodic adjustments to ensure that the first damper 142A and the second damper 142B are positioned such that the tip 174 of the blade body 168 contacts the conveyor belt 104. At step 430, the ECU 178 determines whether the elapsed time T is less than a predetermined timing threshold. If the ECU 178 determines at step 430 that the elapsed time T is less than the predetermined timing threshold, the method 400 returns to step 428 to continue detecting the elapsed time T. Alternatively, if the ECU 178 determines at step 430 that the elapsed time T is not less than, e.g., equal to or greater than, the predetermined timing threshold, the method 400 proceeds to checkpoint B and subsequently step 426. Accordingly, this process continues indefinitely or until the conveyor assembly 100 is deactivated.

As described herein, the conveyor assembly 100 includes the user interface 318 for selecting and controlling the positioning of the first damper 142A and the second damper 142B. Specifically, the first damper 142A and the second damper 142B may be operated in a manual mode by operating the UP damper button 318C and the DOWN damper button 318D. In the manual mode, steps 406-430 are performed by an operator manually selecting the UP damper button 318C and the DOWN damper button 318D. Alternatively, the first damper 142A and the second damper 142B may be operated in an auto mode in which the first motor 294A and the second motor 294B are operated by the ECU 178 during steps 406-430 without any operator intervention.

From the above, it is to be appreciated that defined herein is a conveyor assembly that includes a belt cleaner tension system for positioning a blade relative to a surface of a conveyor belt. The belt cleaner tension system includes a blade and a damper assembly. The damper assembly includes a damper, a motor operable to position the damper between a retracted position and an extended position, a current sensor for measuring a current of the motor, a damper linkage rotatably coupled to the damper, and a blade linkage pivotally coupled to the damper linkage and a first end of the blade. When the current sensor detects a current of the motor being less than a predetermined current threshold, the motor is operated in a first mode such that the damper is moved toward the extended position and the blade is moved toward a contact position.

Further aspects of the embodiments described herein are provided by the subject matter of the following clauses:

A belt cleaner tension system comprising: a blade; and a damper assembly comprising: a damper; a motor operable to position the damper between a retracted position and an extended position; a current sensor for measuring a current of the motor; a damper linkage rotatably coupled to the damper; and a blade linkage pivotally coupled to the damper linkage and a first end of the blade, wherein, when the current sensor detects a current of the motor being less than a predetermined current threshold, the motor is operated in a first mode such that the damper is moved toward the extended position and the blade is moved toward a contact position.

The belt cleaner tension system of any preceding clause, wherein the damper comprises: an inner housing; an outer housing slidable relative to the inner housing; wherein a length of the damper when in the retracted position is less than a length of the damper when in the extended position.

The belt cleaner tension system of any preceding clause, further comprising: an upper seal provided retained within the inner housing and provided between the inner housing and the outer housing; and a lower seal retained within the outer housing and provided between the inner housing and the outer housing.

The belt cleaner tension system of any preceding clause, wherein the damper comprises: a screw; and a nut threadedly engaging the screw and rotatably fixed to the inner housing, wherein rotation of the screw in a first direction results in the nut moving in a first linear direction along the inner housing, wherein rotation of the screw in an opposite second direction results in the nut moving in an opposite second linear direction along the inner housing.

The belt cleaner tension system of any preceding clause, wherein: a first slot is formed in the inner housing; and the nut includes an inner pin extending through the first slot to inhibit rotation of the nut relative to the inner housing.

The belt cleaner tension system of any preceding clause, wherein: a second slot is formed in the inner housing; and an outer pin extends through the outer housing and the second slot to inhibit rotation of the outer housing relative to the inner housing.

The belt cleaner tension system of any preceding clause, wherein the damper comprises: a biasing member positioned between a lower spring seat of the nut and an upper spring seat of the outer housing, wherein movement of the nut in the first linear direction results in the damper moving toward the extended position, wherein movement of the nut in the second linear direction results in the damper moving toward the retracted position.

The belt cleaner tension system of any preceding clause, further comprising: a screw gear fixed to the screw; a motor gear; and a belt coupling the screw gear and the motor gear.

The belt cleaner tension system of any preceding clause, wherein: operation of the motor in a first mode results in rotation of the motor gear, the screw gear, and the screw in the first direction to move the nut in the first linear direction along the inner housing; and operation of the motor in a second mode results in rotation of the motor gear, the screw gear, and the screw in the first direction to move the nut in the second linear direction along the inner housing.

The belt cleaner tension system of any preceding clause, further wherein, when the current sensor detects the current of the motor being is equal to or greater than the predetermined current threshold, operation of the motor is ceased.

A conveyor assembly comprising: a frame; a conveyor belt extending through an open interior of the frame; a blade positioned within the open interior of the frame; and a first damper assembly coupled to the frame, the first damper assembly comprising: a damper; a motor operable to position the damper between a retracted position and an extended position; a current sensor for measuring a current of the motor; a damper linkage rotatably coupled to the damper; and a blade linkage fixed to the damper linkage and a first end of the blade, wherein, when the current sensor detects a current of the motor being less than a predetermined current threshold, the motor is operated in a first mode such that the damper is moved toward the extended position and the blade is moved toward a contact position to contact an outer surface of the conveyor belt.

The conveyor assembly of any preceding clause, further comprising a bracket mounted to an outer surface of the frame, wherein the damper comprises: an inner housing including a fixed end; an outer housing including a free end, the outer housing slidable relative to the inner housing; wherein the fixed end of the inner housing is fixed to the bracket, wherein the free end of the outer housing is rotatably coupled to the damper linkage.

The conveyor assembly of any preceding clause, wherein the damper comprises: a screw; and a nut threadedly engaging the screw and rotatably fixed to the inner housing, wherein rotation of the screw in a first direction results in the nut moving in a first linear direction along the inner housing, wherein rotation of the screw in an opposite second direction results in the nut moving in an opposite second linear direction along the inner housing.

The conveyor assembly of any preceding clause, wherein the damper comprises: a biasing member positioned between a lower spring seat of the nut and an upper spring seat of the outer housing, wherein movement of the nut in the first linear direction results in the damper moving toward the extended position, wherein movement of the nut in the second linear direction results in the damper moving toward the retracted position.

The conveyor assembly of any preceding clause, further comprising: a screw gear fixed to the screw; a motor gear; and a belt coupling the screw gear and the motor gear, wherein operation of the motor in a first mode results in rotation of the motor gear, the screw gear, and the screw in the first direction to move the nut in the first linear direction along the inner housing, wherein operation of the motor in a second mode results in rotation of the motor gear, the screw gear, and the screw in the first direction to move the nut in the second linear direction along the inner housing.

The conveyor assembly of any preceding clause, further comprising a second damper assembly coupled to the frame opposite the first damper assembly, the second damper assembly comprising: a damper; a motor operable to position the damper between a retracted position and an extended position; a damper linkage rotatably coupled to the damper; and a blade linkage fixed to the damper linkage and a second end of the blade opposite the first end of the blade.

A method comprising: operating the motor in a first mode to position a damper of a damper assembly toward an extended position; detecting a current of the motor; in response to determining the current of the motor is less than a predetermined current threshold, continuing operation of the motor in the first mode; in response to determining that the current of the motor is equal to or greater than the predetermined current threshold, ceasing operation of the motor in the first mode.

The method of any preceding clause, further comprising: moving a blade toward a contact position closer to an outer surface of a conveyor belt when the motor is operated in the first mode such that damper is moved toward the extended position; and moving the blade toward a noncontact position away from the outer surface of the conveyor belt when the motor is operated in a second mode such that the damper is moved toward the retracted position.

The method of any preceding clause, further comprising: determining whether an elapsed time is equal to or greater than a predetermined timing threshold; and in response to determining that the elapsed time is equal to or greater than the predetermined timing threshold: operating the motor in a second mode to move the damper assembly toward the retracted position; and subsequently operating the motor in the first mode to move the damper assembly toward the extended position until a current of the motor is equal to or greater than the predetermined current threshold.

The method of any preceding clause, further comprising: detecting a plurality of readings of the current of the motor over a period of time; averaging the plurality of readings of the current of the motor; and set the predetermined current threshold based on the averaging of the plurality of readings.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A belt cleaner tension system comprising:
a blade; and
a damper assembly comprising:
a damper;
a motor operable to position the damper between a retracted position and an extended position;
a current sensor for measuring a current of the motor;
a damper linkage rotatably coupled to the damper; and
a blade linkage pivotally coupled to the damper linkage and a first end of the blade,
wherein, when the current sensor detects a current of the motor being less than a predetermined current threshold, the motor is operated in a first mode such that the damper is moved toward the extended position and the blade is moved toward a contact position.

2. The belt cleaner tension system of claim 1, wherein the damper comprises:
an inner housing;
an outer housing slidable relative to the inner housing;
wherein a length of the damper when in the retracted position is less than a length of the damper when in the extended position.

3. The belt cleaner tension system of claim 2, further comprising:
an upper seal provided retained within the inner housing and provided between the inner housing and the outer housing; and
a lower seal retained within the outer housing and provided between the inner housing and the outer housing.

4. The belt cleaner tension system of claim 2, wherein the damper comprises:
a screw; and
a nut threadedly engaging the screw and rotatably fixed to the inner housing,
wherein rotation of the screw in a first direction results in the nut moving in a first linear direction along the inner housing,
wherein rotation of the screw in an opposite second direction results in the nut moving in an opposite second linear direction along the inner housing.

5. The belt cleaner tension system of claim 4, wherein:
a first slot is formed in the inner housing; and
the nut includes an inner pin extending through the first slot to inhibit rotation of the nut relative to the inner housing.

6. The belt cleaner tension system of claim 4, wherein:
a second slot is formed in the inner housing; and
an outer pin extends through the outer housing and the second slot to inhibit rotation of the outer housing relative to the inner housing.

7. The belt cleaner tension system of claim 4, wherein the damper comprises:
a biasing member positioned between a lower spring seat of the nut and an upper spring seat of the outer housing,
wherein movement of the nut in the first linear direction results in the damper moving toward the extended position,
wherein movement of the nut in the second linear direction results in the damper moving toward the retracted position.

8. The belt cleaner tension system of claim 4, further comprising:
a screw gear fixed to the screw;
a motor gear; and
a belt coupling the screw gear and the motor gear.

9. The belt cleaner tension system of claim 8, wherein:
operation of the motor in a first mode results in rotation of the motor gear, the screw gear, and the screw in the first direction to move the nut in the first linear direction along the inner housing; and
operation of the motor in a second mode results in rotation of the motor gear, the screw gear, and the screw in the first direction to move the nut in the second linear direction along the inner housing.

10. The belt cleaner tension system of claim 1, wherein, when the current sensor detects the current of the motor being is equal to or greater than the predetermined current threshold, operation of the motor is ceased.

11. A conveyor assembly comprising:
a frame;
a conveyor belt extending through an open interior of the frame;
a blade positioned within the open interior of the frame; and
a first damper assembly coupled to the frame, the first damper assembly comprising:
a damper;
a motor operable to position the damper between a retracted position and an extended position;
a current sensor for measuring a current of the motor;
a damper linkage rotatably coupled to the damper; and
a blade linkage fixed to the damper linkage and a first end of the blade,
wherein, when the current sensor detects a current of the motor being less than a predetermined current threshold, the motor is operated in a first mode such that the damper is moved toward the extended position and the blade is moved toward a contact position to contact an outer surface of the conveyor belt.

12. The conveyor assembly of claim 11, further comprising a bracket mounted to an outer surface of the frame,
wherein the damper comprises:
an inner housing including a fixed end;
an outer housing including a free end, the outer housing slidable relative to the inner housing;
wherein the fixed end of the inner housing is fixed to the bracket,
wherein the free end of the outer housing is rotatably coupled to the damper linkage.

13. The conveyor assembly of claim 12, wherein the damper comprises:
a screw; and
a nut threadedly engaging the screw and rotatably fixed to the inner housing,
wherein rotation of the screw in a first direction results in the nut moving in a first linear direction along the inner housing,
wherein rotation of the screw in an opposite second direction results in the nut moving in an opposite second linear direction along the inner housing.

14. The conveyor assembly of claim 13, wherein the damper comprises:
a biasing member positioned between a lower spring seat of the nut and an upper spring seat of the outer housing,
wherein movement of the nut in the first linear direction results in the damper moving toward the extended position,
wherein movement of the nut in the second linear direction results in the damper moving toward the retracted position.

15. The conveyor assembly of claim 13, further comprising:
a screw gear fixed to the screw;
a motor gear; and
a belt coupling the screw gear and the motor gear,
wherein operation of the motor in a first mode results in rotation of the motor gear, the screw gear, and the screw in the first direction to move the nut in the first linear direction along the inner housing,
wherein operation of the motor in a second mode results in rotation of the motor gear, the screw gear, and the screw in the first direction to move the nut in the second linear direction along the inner housing.

16. The conveyor assembly of claim 11, further comprising a second damper assembly coupled to the frame opposite the first damper assembly, the second damper assembly comprising:
a damper;
a motor operable to position the damper between a retracted position and an extended position;
a damper linkage rotatably coupled to the damper; and
a blade linkage fixed to the damper linkage and a second end of the blade opposite the first end of the blade.

17. A method comprising:
operating a motor in a first mode to position a damper of a damper assembly toward an extended position;
detecting a current of the motor;
in response to determining the current of the motor is less than a predetermined current threshold, continuing operation of the motor in the first mode; and
in response to determining that the current of the motor is equal to or greater than the predetermined current threshold, ceasing operation of the motor in the first mode.

18. The method of claim 17, further comprising:
moving a blade toward a contact position closer to an outer surface of a conveyor belt when the motor is operated in the first mode such that damper is moved toward the extended position; and
moving the blade toward a noncontact position away from the outer surface of the conveyor belt when the motor is operated in a second mode such that the damper is moved toward a retracted position.

19. The method of claim 18, further comprising:
determining whether an elapsed time is equal to or greater than a predetermined timing threshold; and
in response to determining that the elapsed time is equal to or greater than the predetermined timing threshold:
operating the motor in a second mode to move the damper assembly toward the retracted position; and
subsequently operating the motor in the first mode to move the damper assembly toward the extended position until a current of the motor is equal to or greater than the predetermined current threshold.

20. The method of claim 17, further comprising:
detecting a plurality of readings of the current of the motor over a period of time;
averaging the plurality of readings of the current of the motor; and
setting the predetermined current threshold based on the averaging of the plurality of readings.
